(19) United States
(12) Patent Application Publication
(10) Pub. No.: US 2023/0340280 A1
(43) Pub. Date: Oct. 26, 2023

(54) RHEOLOGY-MODIFYING DIFUNCTIONAL COMPOUND

(71) Applicant: COATEX, Genay (FR)

(72) Inventors: Yves MATTER, Reyrieux (FR); Denis RUHLMANN, Genay (FR); Jean-Marc SUAU, Lucenay (FR)

(73) Assignee: COATEX, Genay (FR)

(21) Appl. No.: 18/004,946

(22) PCT Filed: Jul. 26, 2021
(86) PCT No.: PCT/FR2021/000084

§ 371 Date: Jan. 10, 2023

(30) Foreign Application Priority Data
Jul. 27, 2020 (FR) 2007894

(51) Int. Cl. C09D 7/65; C09D 7/43; C09D 17/00

(52) U.S. Cl. CPC C09D 7/43; C09D 7/65; C09D 17/001

(57) ABSTRACT

The invention relates to a rheology-modifying difunctional compound. The invention also provides an aqueous composition comprising a difunctional compound according to the invention and a method for controlling the viscosity of an aqueous composition using the difunctional compound according to the invention.

The invention relates to a rheology-modifying difunctional compound. The invention also provides an aqueous composition comprising a difunctional compound according to the invention and a method for controlling the viscosity of an aqueous composition using the difunctional compound according to the invention.

In general, for aqueous coating compositions, and in particular for aqueous paint or varnish compositions, it is necessary to control the viscosity both for low or medium shear gradients and for high shear gradients. Indeed, during its preparation, storage, application or drying, a paint formulation is subjected to numerous stresses requiring particularly complex rheological properties.

When paint is stored, the pigment particles tend to settle by gravity. Stabilising the dispersion of these pigment particles therefore requires a paint formulation having high viscosity at very low shear gradients corresponding to the limiting velocity of the particles.

Paint uptake is the amount of paint taken up by an application tool such as, for example, a paintbrush, a brush or a roller. If the tool takes up a large amount of paint when dipped into and removed from the can, it will not need to be dipped as often. Paint uptake increases as the viscosity increases. The calculation of the equivalent shear gradient is a function of the paint flow velocity for a particular thickness of paint on the tool. The paint formulation should therefore also have a high viscosity at low or medium shear gradients.

Moreover, the paint must have a high filling property so that, when applied to a substrate, a thick coat of paint is deposited at each stroke. A high filling property therefore makes it possible to obtain a thicker wet film of paint with each stroke of the tool. The paint formulation must therefore have a high viscosity at high shear gradients.

High viscosity at high shear gradients will also reduce or eliminate the risk of splattering or dripping when the paint is being applied.

Reduced viscosity at low or medium shear gradients will also result in a neat, taut appearance after the paint has been applied, particularly a single-coat paint, to a substrate which will then have a very even surface finish having no bumps or indentations. The final visual appearance of the dry coat is thus greatly improved.

Furthermore, once the paint has been applied to a surface, especially a vertical surface, it should not run. The paint formulation thus needs to have a high viscosity at low and medium shear gradients.

Lastly, once the paint has been applied to a surface, it should have a high levelling capacity. The paint formulation must then have a reduced viscosity at low and medium shear gradients.

Documents EP0761779 and EP0761780 describe thickening and heat-resistant diurethane compounds. Document CA1341003 discloses polyethoxylated and polypropoxylated diurethane compounds. Document FR2113316 discloses diurethane compounds for textile printing pulp. Document JPH11228686 discloses certain compounds prepared by reacting halides and aromatic compounds. Document WO9631550 describes poly(acetal-polyether) compounds prepared from a dibrominated compound and from a polyol.

HEUR (hydrophobically modified ethoxylated urethane)-type compounds are known as rheology-modifying agents.

However, the known HEUR-type compounds do not always make it possible to provide a satisfactory solution. In particular, the rheology-modifying compounds of the prior art do not always allow for effective viscosity control or do not always achieve a satisfactory improvement in the compromise between Stormer viscosity (measured at low or medium shear gradients and expressed in KUs) and ICI viscosity (measured at high or very high shear gradients and expressed in s⁻¹). In particular, the known rheology-modifying compounds do not always make it possible to increase the ICI viscosity/Stormer viscosity ratio.

There is therefore a need for improved rheology-modifying agents. The difunctional compound according to the invention makes it possible to provide a solution to all or part of the problems of the rheology-modifying agents in the prior art.

Thus, the invention provides a difunctional compound T prepared by reacting:
a. one molar equivalent of at least one reagent compound (a) chosen among:
   a diisocyanate compound (a1),
   a dihalogenated compound (a2) of formula (I): 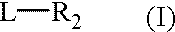
   wherein R independently represents Cl, Br or I and L independently represents a CH₂ group, and
b. two molar equivalents of at least two different polyethoxylated compounds (b) chosen among:
   the straight aliphatic monoalcohols (b1) comprising from 6 to 40 polyethoxylated carbon atoms comprising from 80 to 500 oxyethylene groups,
   the branched aliphatic monoalcohols (b2) comprising from 6 to 40 polyethoxylated carbon atoms comprising from 80 to 500 oxyethylene groups,
   the cycloaliphatic monoalcohols (b3) comprising from 6 to 40 polyethoxylated carbon atoms comprising from 80 to 500 ethoxylated groups,
   the monoaromatic monoalcohols (b4) comprising from 6 to 30 polyethoxylated carbon atoms comprising from 80 to 500 ethoxylated groups,
   the polyaromatic monoalcohols (b5) comprising from 10 to 80 polyethoxylated carbon atoms comprising from 80 to 500 oxyethylene groups.

Essentially according to the invention, the difunctional compound T is prepared from at least one compound (a1) comprising two isocyanate groups or from at least one compound (a2) comprising two halogen atoms and from a compound (b) capable of reacting with these isocyanate groups and comprising a saturated, unsaturated, or aromatic hydrocarbon chain combined with a polyethoxylated chain. Preferably according to the invention, this reagent compound (b) is a monohydroxyl compound.

Preferably according to the invention, the condensation of compounds (a1) and (b) is carried out in the presence of a catalyst. This catalyst can be chosen among an amine, preferably 1,8-diazabicyclo[5.4.0]undec-7-ene (DBU), a derivative of a metal chosen among Al, Bi, Sn, Hg, Pb, Mn, Zn, Zr, Ti. Traces of water may also participate in the catalysis of the reaction. As examples of metal derivatives, a derivative is preferably chosen among dibutyl bismuth dilaurate, dibutyl bismuth diacetate, dibutyl bismuth oxide, bismuth carboxylate, dibutyltin dilaurate, dibutyltin diacetate, dibutyltin oxide, a mercury derivative, a lead derivative, zinc salts, manganese salts, a compound comprising chelated zirconium, a compound comprising chelated aluminium. The preferred metal derivative is chosen among a Bi derivative, an Sn derivative and a Ti derivative.

Preferably according to the invention, the condensation of compounds (a2) and (b) is carried out in the presence of a catalyst, in particular a basic catalyst. This catalyst may be chosen among strong bases such as KOH, NaOH.

Preferably according to the invention, the reaction uses a single compound (a) or the reaction uses two or three different compounds (a).

According to the invention, the polyisocyanate compound (a1) comprises on average two isocyanate groups. Generally, the polyisocyanate compound (a1) comprises on average 2 ± 10 mol% isocyanate groups.

According to the invention, the diisocyanate compounds are symmetric diisocyanate compounds or asymmetric diisocyanate compounds. The symmetric diisocyanate compounds comprise two isocyanate groups that have the same reactivity. The asymmetric diisocyanate compounds comprise two isocyanate groups that have different reactivities.

Preferably according to the invention, the compound (a1) is chosen among:
the symmetric aromatic diisocyanate compounds, preferably:
   * 2,2′-diphenylmethylene diisocyanate (2,2′-MDI) and 4,4′-diphenylmethylene diisocyanate (4,4′-MDI);
   * 4,4′-dibenzyl diisocyanate (4,4′-DBDI);
   * 2,6-toluene diisocyanate (2,6-TDI);
   * m-xylylene diisocyanate (m-XDI);
the symmetric alicyclic diisocyanate compounds, preferably methylene bis(4-cyclohexylisocyanate) (H₁₂MDI);
the symmetric aliphatic diisocyanate compounds, preferably hexamethylene diisocyanate (HDI), pentamethylene diisocyanate (PDI);
the asymmetric aromatic diisocyanate compounds, preferably:
   * 2,4′-diphenylmethylene diisocyanate (2,4′-MDI);
   * 2,4′-dibenzyl diisocyanate (2,4′-DBDI);
   * 2,4-toluene diisocyanate (2,4-TDI);
the asymmetric alicyclic diisocyanate compounds, preferably isophorone diisocyanate (IPDI).

Preferably according to the invention, the compound (a1) is chosen among IPDI, HDI, H₁₂MDI and combinations thereof.

According to the invention, the dihalogenated compound (a2) comprises on average two halogen groups. Generally, the dihalogenated compound (a2) comprises on average 2 ± 10 mol% of halogen groups.

Preferably according to the invention, the compound (a2) is a compound of formula (I) wherein R independently represents Br or I, preferably Br. More preferably according to the invention, the compound (a2) is chosen among dibromomethane, diiodomethane and combinations thereof.

According to the invention, the monoalcohols are compounds comprising a single hydroxyl (OH) group that is terminal. According to the invention, the polyethoxylated monoalcohols are compounds comprising a hydrocarbon chain that comprises several ethoxylated groups and a terminal hydroxyl (OH) group. According to the invention, the polyethoxylated monoalcohols are compounds of formula Q—(LO)ₙ—H in which Q represents a hydrocarbon chain, n represents the number of polyethoxylations and L, identical or different, independently represents a straight or branched alkylene group comprising from 1 to 4 carbon atoms. According to the invention, the non-alkoxylated monoalcohols are compounds comprising a hydrocarbon chain and a single hydroxyl (OH) group that is terminal. According to the invention, the non-alkoxylated monoalcohols are compounds of formula Q′-OH in which Q′ represents a hydrocarbon chain. According to the invention, the number of carbon atoms defining monoalcohols (b1) to (b5) therefore corresponds to the number of carbon atoms in the Q or Q′ groups’.

Preferably according to the invention, the polyethoxylated monoalcohols comprise from 100 to 500 ethoxylated groups, preferably from 80 to 400 ethoxylated groups or from 100 to 200 ethoxylated groups. According to the invention, the polyethoxylated compounds (b) used may comprise a number of different ethoxylated groups.

Essentially according to the invention, the compound T is a compound comprising ethoxylated groups. Preferentially according to the invention, the compound T has a degree of polyethoxylation that is strictly greater than 80 and up to 500 or comprised between 100 and 500 or between 100 and 502. The degree of polyethoxylation defines the number of ethoxylated groups comprised in this compound.

Preferably according to the invention, the compound (b) is such that:
the hydrocarbon chain of the monoalcohol (b1) comprises from 6 to 30 carbon atoms, preferably from 6 to 20 carbon atoms or from 8 to 16 carbon atoms; more preferentially, the monoalcohol (b1) is chosen among polyethoxylated n-octanol, polyethoxylated n-decanol, polyethoxylated n-dodecanol, polyethoxylated n-hexadecanol, or
the hydrocarbon chain of the monoalcohol (b2) comprises from 6 to 30 carbon atoms, preferably from 6 to 20 carbon atoms or from 8 to 16 carbon atoms; more preferentially, the monoalcohol (b2) is chosen among polyethoxylated ethylhexanol, polyethoxylated isooctanol, polyethoxylated isononanol, polyethoxylated isodecanol, polyethoxylated propyl heptanol, polyethoxylated butyl octanol, polyethoxylated isododecanol, polyethoxylated isohexadecanol, a polyethoxylated oxo alcohol, a polyethoxylated Guerbet alcohol, or
the hydrocarbon chain of the monoalcohol (b3) comprises from 6 to 30 carbon atoms, preferably from 6 to 20 carbon atoms or from 8 to 20 carbon atoms; more preferentially, the monoalcohol (b3) is chosen among polyethoxylated ethylcyclohexanol, polyethoxylated n-nonyl-cyclohexanol, polyethoxylated n-dodecyl-cyclohexanol, or
the hydrocarbon chain of the monoalcohol (b4) comprises from 12 to 30 carbon atoms or from 12 to 22 carbon atoms; preferably, the monoalcohol (b4) is chosen among polyethoxylated n-pentadodecyl-phenol or
the hydrocarbon chain of the monoalcohol (b5) comprises from 10 to 60 carbon atoms; preferably, the monoalcohol (b5) is chosen among polyethoxylated naphthol, polyethoxylated distyryl phenol, polyethoxylated tristyryl phenol, polyethoxylated pentastyryl cumyl phenol.

Essentially according to the invention, the compound T is prepared using a monoalcohol and in the absence of diols or of triols or in the absence of any compound comprising at least two hydroxyl (OH) groups.

In addition to a difunctional compound T, the invention also relates to a method for preparing this compound.

Thus, the invention provides a method for preparing a difunctional compound T by reacting:
a. one molar equivalent of at least one reagent compound (a) chosen among:
   a diisocyanate compound (a1),
   a dihalogenated compound (a2), and
b. two molar equivalents of at least two different polyethoxylated compounds (b) chosen among:
   the straight aliphatic monoalcohols (b1) comprising from 6 to 40 polyethoxylated carbon atoms comprising from 80 to 500 ethoxylated groups,
   the branched aliphatic monoalcohols (b2) comprising from 6 to 40 polyethoxylated carbon atoms comprising from 80 to 500 ethoxylated groups,
   the cycloaliphatic monoalcohols (b3) comprising from 6 to 40 polyethoxylated carbon atoms comprising from 80 to 500 ethoxylated groups,
   the monoaromatic monoalcohols (b4) comprising from 6 to 30 polyethoxylated carbon atoms comprising from 80 to 500 ethoxylated groups,
   the polyaromatic monoalcohols (b5) comprising from 10 to 80 polyethoxylated carbon atoms comprising from 80 to 500 ethoxylated groups.

Preferably according to the invention for the preparation method according to the invention, the condensation of compounds (a1) and (b) is carried out in the presence of a catalyst. More preferably, the reaction is catalysed using an amine, preferably using 1,8-diazabicyclo[5.4.0]undec-7-ene (DBU), or at least one derivative of a metal chosen among Al, Bi, Sn, Hg, Pb, Mn, Zn, Zr, Ti. Traces of water may also participate in the catalysis of the reaction. As examples of metal derivatives, a derivative is preferably chosen among dibutyl bismuth dilaurate, dibutyl bismuth diacetate, dibutyl bismuth oxide, bismuth carboxylate, dibutyltin dilaurate, dibutyltin diacetate, dibutyltin oxide, a mercury derivative, a lead derivative, zinc salts, manganese salts, a compound comprising chelated zirconium, a compound comprising chelated aluminium. The preferred metal derivative is chosen among a Bi derivative, an Sn derivative and a Ti derivative.

Preferably according to the invention, the condensation of compounds (a2) and (b) is carried out in the presence of a catalyst, in particular a basic catalyst. This catalyst may be chosen among strong bases such as KOH, NaOH.

Advantageously according to the invention, the condensation of compounds (a) and (b) is carried out in an organic solvent. The preferred organic solvents are solvents that are non-reactant with the isocyanate groups of the compound (a1) or non-reactant with the halogen atoms of the compound (a2), in particular the solvents chosen among the hydrocarbon solvents (particularly C₈ to C₃₀ petroleum cuts), the aromatic solvents (particularly toluene and its derivatives) and combinations thereof. More preferably according to the invention, condensation is carried out directly with the different reagents or is carried out in toluene.

At the end of the preparation of the compound T according to the invention, a solution of the compound in an organic solvent is obtained. Such a solution can be used directly. Also according to the invention, the organic solvent can be separated and the compound T dried. Such a compound T according to the invention, which is dried, can then be used in solid form, for example in powder or pellet form.

In addition to the difunctional compound T and a method for preparing this compound, the invention also relates to an aqueous composition comprising at least one difunctional compound T according to the invention. The invention also relates to an aqueous composition comprising at least one difunctional compound T prepared according to the preparation method according to the invention.

Advantageously, the difunctional compound according to the invention is a compound having a hydrophilic character. It can be formulated in an aqueous medium.

The aqueous composition according to the invention may also comprise at least one additive, in particular an additive chosen among:
an amphiphilic compound, in particular a surfactant compound, preferably a hydroxylated surfactant compound, for example alkyl-polyalkylene glycol, in particular alkyl-polyethylene glycol and alkyl-polypropylene glycol;
a polysaccharide derivative, for example cyclodextrin, cyclodextrin derivative, polyethers, alkyl-glucosides;
solvents, in particular coalescing solvents, and hydrotropic compounds, for example glycol, butyl glycol, butyldiglycol, mono propylene glycol, ethylene glycol, ethylenediglycol, Dowanol products with CAS number 34590-94-8, Texanol products with CAS number 25265-77-4;
anti-foaming agents, biocide agents.

The invention also provides an aqueous formulation that can be used in many technical fields. The aqueous formulation according to the invention comprises at least one composition according to the invention and may comprise at least one organic or mineral pigment or organic, organo-metallic or mineral particles, for example calcium carbonate, talc, kaolin, mica, silicates, silica, metal oxides, in particular titanium dioxide, iron oxides. The aqueous formulation according to the invention can also comprise at least one agent chosen among a particle-spacer agent, a dispersing agent, a stabilising steric agent, an electrostatic stabiliser, an opacifying agent, a solvent, a coalescing agent, an anti-foaming agent, a preservative agent, a biocide agent, a spreading agent, a thickening agent, a film-forming copolymer, and mixtures thereof.

Depending on the particular difunctional compound or the additives that it comprises, the formulation according to the invention can be used in many technical fields. Thus, the formulation according to the invention can be a coating formulation. Preferably, the formulation according to the invention is an ink formulation, a binder formulation, a varnish formulation, a paint formulation, for example a decorative paint or an industrial paint. Preferably, the formulation according to the invention is a paint formulation.

The invention also provides a concentrated aqueous pigment pulp comprising at least one difunctional compound T according to the invention or at least one difunctional compound T prepared according to the preparation method according to the invention and at least one coloured organic or mineral pigment.

The difunctional compound according to the invention has properties that make it possible to use it to modify or control the rheology of the medium comprising it. Thus, the invention also provides a method for controlling the viscosity of an aqueous composition.

This viscosity control method according to the invention comprises the addition of at least one difunctional compound T according to the invention to an aqueous composition. This viscosity control method may also include the addition of at least one difunctional compound T prepared according to the preparation method according to the invention.

Preferably, the viscosity control method according to the invention is carried out using an aqueous composition according to the invention. Also preferably, the viscosity control method according to the invention is carried out using an aqueous formulation according to the invention.

The particular, advantageous or preferred characteristics of the difunctional compound T according to the invention define aqueous compositions according to the invention, formulations according to the invention, pigment pulp and viscosity control methods which are also particular, advantageous or preferred.

The following examples illustrate the various aspects of the invention.

### Example 1: Preparation of Urethane Compounds According to the Invention

### Example 1-1: Preparation of a Compound T1 According to the Invention

In a 3 L glass reactor equipped with a mechanical stirring rod, a vacuum pump, and a nitrogen inlet and heated by means of a double jacket in which oil circulates, 401.10 g of ethoxylated dodecanol is introduced with 140 mol of ethylene oxide (MM = 6,355 Da) and 95.05 g of branched dodecanol ethoxylated with 30 mol of ethylene oxide (MM = 1,506 Da) that is heated to 90° C. in an inert atmosphere. This mixture is dehydrated. Under stirring and in an inert atmosphere, 7.02 g of IPDI (MM = 222.3 g/mol) are then added in one hour in the presence of 200 ppm of bismuth carboxylate catalyst. When the addition is complete, the reaction mixture is left to stir for 60 minutes at 90° C. ± 1° C. Then, the absence of isocyanate is checked by back titration. 1 g is collected from the reaction medium to which an excess of dibutylamine (1 mol, for example) is added, which reacts with any isocyanate groups that may be present in the medium. Any unreacted dibutylamine is then assayed with hydrochloric acid (1 N, for example). The number of isocyanate groups present in the reaction medium can then be deduced. If this number is not zero, the reaction is continued for 15-minute periods until the reaction is completed. When the level reaches zero, the compound T1 obtained is formulated in water to which is added 1,000 ppm of a biocide agent (Biopol SMV Chemipol) and 1,000 ppm of an anti-foaming agent (Tego 1488 Evonik). A composition 1 is obtained consisting of 20% by mass of compound T1 according to the invention and 80% by mass of water.

### Example 1-2: Preparation of a Compound T2 According to the Invention

In a 3 L glass reactor equipped with a mechanical stirring rod, a vacuum pump, and a nitrogen inlet and heated by means of a double jacket in which oil circulates, 448.70 g of ethoxylated dodecanol is introduced with 140 mol of ethylene oxide (MM = 6,355 Da) and 37.56 g of tristyryl phenol ethoxylated with 3 mol of ethylene oxide (MM = 532 Da) that is heated to 90° C. in an inert atmosphere. This mixture is dehydrated. Under stirring and in an inert atmosphere, 7.85 g of IPDI (MM = 222.3 g/mol) are then added in one hour in the presence of 200 ppm of bismuth carboxylate catalyst. When the addition is complete, the reaction mixture is left to stir for 60 minutes at 90° C. ± 1° C. As described in Example 1-1, the absence of isocyanate is checked by back titration. If this number is not zero, the reaction is continued for 15-minute periods until the reaction is completed. When the level reaches zero, the compound T2 obtained is formulated in water to which is added 1,000 ppm of a biocide agent (Biopol SMV Chemipol) and 1,000 ppm of an anti-foaming agent (Tego 1488 Evonik). A composition 2 is obtained consisting of 20% by mass of compound T2 according to the invention and 80% by mass of water.

### Example 1-3: Preparation of a Compound T3 According to the Invention

In a 3 L glass reactor equipped with a mechanical stirring rod, a vacuum pump, and a nitrogen inlet and heated by means of a double jacket in which oil circulates, 349.70 g of ethoxylated dodecanol is introduced with 140 mol of ethylene oxide (MM = 6,355 Da) and 167.61 g of tristyryl phenol ethoxylated with 60 mol of ethylene oxide (MM = 3,046 Da) that is heated to 90° C. in an inert atmosphere. This mixture is dehydrated.

Under stirring and in an inert atmosphere, 6.12 g of IPDI (MM = 222.3 g/mol) are then added in one hour in the presence of 200 ppm of bismuth carboxylate catalyst. When the addition is complete, the reaction mixture is left to stir for 60 minutes at 90° C. ± 1° C. As described in Example 1-1, the absence of isocyanate is checked by back titration. If this number is not zero, the reaction is continued for 15-minute periods until the reaction is completed. When the level reaches zero, the compound T3 obtained is formulated in water to which is added 1,000 ppm of a biocide agent (Biopol SMV Chemipol) and 1,000 ppm of an anti-foaming agent (Tego 1488 Evonik). A composition 3 is obtained consisting of 20% by mass of compound T3 according to the invention and 80% by mass of water.

### Example 1-4: Preparation of a Compound T4 According to the Invention

In a 3 L glass reactor equipped with a mechanical stirring rod, a vacuum pump, and a nitrogen inlet and heated by means of a double jacket in which oil circulates, 400.60 g of ethoxylated dodecanol is introduced with 140 mol of ethylene oxide (MM = 6,355 Da) and 75.52 g of dodecanol ethoxylated with 23 mol of ethylene oxide (MM = 1,198 Da) that is heated to 90° C. in an inert atmosphere. This mixture is dehydrated.

Under stirring and in an inert atmosphere, 7.01 g of IPDI (MM = 222.3 g/mol) are then added in one hour in the presence of 200 ppm of bismuth carboxylate catalyst. When the addition is complete, the reaction mixture is left to stir for 60 minutes at 90° C. ± 1° C. As described in Example 1-1, the absence of isocyanate is checked by back titration. If this number is not zero, the reaction is continued for 15-minute periods until the reaction is completed. When the level reaches zero, the compound T4 obtained is formulated in water to which is added 1,000 ppm of a biocide agent (Biopol SMV Chemipol) and 1,000 ppm of an anti-foaming agent (Tego 1488 Evonik). A composition 4 is obtained consisting of 20% by mass of compound T4 according to the invention and 80% by mass of water.

### Example 1-5: Preparation of a Compound T5 According to the Invention

In a 3 L glass reactor equipped with a mechanical stirring rod, a vacuum pump, and a nitrogen inlet and heated by means of a double jacket in which oil circulates, 451.20 g of ethoxylated dodecanol is introduced with 140 mol of ethylene oxide (MM = 6,355 Da) and 33.80 g of cardanol ethoxylated with 4 mol of ethylene oxide (MM = 476 Da) that is heated to 90° C. in an inert atmosphere. This mixture is dehydrated. Under stirring and in an inert atmosphere, 7.89 g of IPDI (MM = 222.3 g/mol) are then added in one hour in the presence of 200 ppm of bismuth carboxylate catalyst. When the addition is complete, the reaction mixture is left to stir for 60 minutes at 90° C. ± 1° C. As described in Example 1-1, the absence of isocyanate is checked by back titration. If this number is not zero, the reaction is continued for 15-minute periods until the reaction is completed. When the level reaches zero, the compound T5 obtained is formulated using a surfactant compound such as ethoxylated alcohol (octanol ethoxylated with ten ethylene oxide equivalents) in water to which is added 1,000 ppm of a biocide agent (Biopol SMV Chemipol) and 1,000 ppm of an anti-foaming agent (Tego 1488 Evonik). A composition 5 is obtained consisting of 20% by mass of compound T5 according to the invention, 5% of surfactant compound and 75% by mass of water.

### Example 1-6: Preparation of a Compound T6 According to the Invention

In a 3 L glass reactor equipped with a mechanical stirring rod, a vacuum pump, and a nitrogen inlet and heated by means of a double jacket in which oil circulates, 351.20 g of ethoxylated tristryl phenol is introduced with 130 mol of ethylene oxide (MM = 6,120 Da) and 174.80 g of tristyryl phenol ethoxylated with 60 mol of ethylene oxide (MM = 3,046 Da) that is heated to 90° C. in an inert atmosphere. This mixture is dehydrated. Under stirring and in an inert atmosphere, 9.65 g of HDI (MM = 168.2 g/mol) are then added in one hour in the presence of 200 ppm of bismuth carboxylate catalyst. When the addition is complete, the reaction mixture is left to stir for 60 minutes at 90° C. ± 1° C. As described in Example 1-1, the absence of isocyanate is checked by back titration. If this number is not zero, the reaction is continued for 15-minute periods until the reaction is completed. When the level reaches zero, the compound T6 obtained is formulated in water to which is added 1,000 ppm of a biocide agent (Biopol SMV Chemipol) and 1,000 ppm of an anti-foaming agent (Tego 1488 Evonik). A composition 6 is obtained consisting of 20% by mass of compound T6 according to the invention and 80% by mass of water.

### Example 2: Preparation of Paint Formulations According to the Invention

Paint formulations F1 to F6 according to the invention are prepared respectively from aqueous compositions 1 to 6 of difunctional compounds T1 to T6 according to the invention. All of the ingredients and proportions (% by mass) used are listed in Table 1.

TABLE 1

| | |
|---|---|
| Ingredients: | Amount (g): |
| water | 99.7 |
| dispersing agent (Coadis BR3 Coatex) | 3.9 |
| Biocide agent (Acticide MBS Thor) | 1.3 |
| anti-foaming agent (Airex 901W Evonik) | 1.31 |
| NH₄OH (28%) | 0.6 |
| TiO₂ pigment (RHD2 Huntsman) | 122.2 |
| CaCO₃ pigment (Omyacoat 850 OG Omya) | 84.6 |
| binding agent (Acronal S790 Basf) | 270.7 |
| monopropylene glycol | 6.5 |
| solvent (Texanol Eastman) | 6.5 |
| anti-foaming agent (Tego 825 Evonik) | 1.0 |
| aqueous composition 1 according to the invention | 28.7 |
| added water | q.s.p 650 g total |

### Example 3: Characterisation of Paint Formulations According to the Invention

For the paint formulations according to the invention, the Brookfield viscosity, measured at 25° C. and at 10 rpm and 100 rpm (µ_{Bk10} and µ_{Bk100} in mPa.s) was determined 24 hours after their preparation using a Brookfield DV-1 viscometer with RVT spindles. The properties of the paint formulations are listed in Table 2.

TABLE 2

| Formulation | Compound | µ_{BK10} | µ_{BK100} |
|---|---|---|---|
| F1 | T1 | 1,780 | 1,020 |
| F2 | T2 | 4,340 | 2,200 |
| F3 | T3 | 6,620 | 2,780 |
| F4 | T4 | 3,760 | 1,650 |
| F5 | T5 | 8,180 | 3,150 |
| F6 | T6 | 5,230 | 3,820 |

The difunctional compounds according to the invention are highly effective in obtaining excellent low and medium shear gradient viscosities for paint compositions.

### Example 4: Characterisation of Paint Formulations According to the Invention

For the paint formulations according to the invention, the Cone Plan viscosity or ICI viscosity, measured at high shear gradient (µI in mPa.s) was determined 24 hours after their preparation and at room temperature, using a Cone & Plate Research Equipment London (REL) viscometer having a measuring range of 0 to 5 poise, and the Stormer viscosity, measured at medium shear gradient (µS in Krebs Units or KUs), was determined using the reference module of a Brookfield KU-2 viscometer. The properties of the paint formulations are listed in Table 3.

TABLE 3

| Formulation | Compound | µI | µS | µI/µS |
|---|---|---|---|---|
| F1 | T1 | 200 | 84 | 2.4 |
| F2 | T2 | 200 | 102 | 2.0 |
| F3 | T3 | 230 | 108 | 2.1 |
| F4 | T4 | 230 | 94 | 2.5 |
| F5 | T5 | 220 | 111 | 2.0 |

The difunctional compounds according to the invention make it possible to prepare paint formulations having particularly well-controlled viscosities. In particular, the µ_{I} viscosity is particularly high and the µ_{I}/µ_{S} ratio is therefore excellent. The compounds according to the invention allow for an excellent compromise between high shear gradient viscosity and low shear gradient viscosity.

### Example 5: Characterisation of a Paint Formulation According to the Invention

Similar to example 4, the Stormer viscosity of formulation 6 comprising compound 6 according to the invention was determined. The Stormer viscosity of this formulation 6 is 122 KU. The difunctional compounds according to the invention thus also make it possible to prepare paint formulations having particularly high viscosity µs.

1. A difunctional compound T prepared by reacting:
a. one molar equivalent of at least one reagent compound (a) selected from the group consisting of a diisocyanate compound (a1), and a dihalogenated compound (a2) of formula (I): 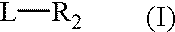
wherein R independently represents Cl, Br or 1 and L independently represents a CH₂ group, and
b. two molar equivalents of at least two different polyethoxylated compounds (b) selected from the group consisting of straight aliphatic monoalcohols (b1) comprising from 6 to 40 polyethoxylated carbon atoms and comprising from 80 to 500 oxyethylene groups, branched aliphatic monoalcohols (b2) comprising from 6 to 40 polyethoxylated carbon atoms and comprising from 80 to 500 oxyethylene groups, cycloaliphatic monoalcohols (b3) comprising from 6 to 40 polyethoxylated carbon atoms and comprising from 80 to 500 oxyethylene groups, monoaromatic monoalcohols (b4) comprising from 6 to 30 polyethoxylated carbon atoms and comprising from 80 to 500 oxyethylene groups, and polyaromatic monoalcohols (b5) comprising from 10 to 80 polyethoxylated carbon atoms and comprising from 80 to 500 oxyethylene groups.

2. The difunctional compound T according to claim 1, comprising a single compound (a) or two or three different compounds (a).

3. The difunctional compound T according to claim 1, wherein the diisocyanate compound (a1) is selected from the group consisting of symmetric aromatic diisocyanate compounds,
symmetric alicyclic diisocyanate compounds,
symmetric aliphatic diisocyanate compounds,
asymmetric aromatic diisocyanate compounds,
and asymmetric alicyclic diisocyanate compounds.

4. The difunctional compound T according to claim 1, wherein the diisocyanate compound (a1) is selected from the group consisting of isophorone diisocyanate (IPDI), hexamethylene diisocyanate (HDI), methylene bis(4-cyclohexylisocyanate) (H₁₂MDI), and combinations thereof.

5. The difunctional compound T according to claim 1, wherein the dihalogenated compound (a2) is a compound of formula (I) wherein R independently represents Br or I.

6. The difunctional compound T according to claim 5, wherein the dihalogenated compound (a2) is selected from the group consisting of dibromomethane, diiodomethane and combinations thereof.

7. The difunctional compound T according to claim 1
wherein a degree of polyethoxylation is between 100 and 500, or
wherein the polyethoxylated compounds (b) comprise from 100 to 500 ethoxylated groups, .

8. The difunctional compound T according to claim 1, wherein the polyethoxylated compound (b) is selected from the group consisting of the monoalcohol (b1) wherein ahydrocarbon chain of the monoalcohol (b1) comprises from 6 to 30 carbon atoms, the monoalcohol (b2) wherein a hydrocarbon chain of the monoalcohol (b2) comprises from 6 to 30 carbon atoms, the monoalcohol (b3) wherein a hydrocarbon chain of the monoalcohol (b3) comprises from 6 to 30 carbon atoms, the monoalcohol (b4) wherein a hydrocarbon chain of the monoalcohol (b4) comprises from 12 to 30 carbon atoms, (b1) and the monoalcohol (b5) wherein a hydrocarbon chain of the monoalcohol (b5) comprises from 10 to 60 carbon atoms; .

9. A method for preparing a difunctional compound T comprising reacting:
a. one molar equivalent of at least one reagent compound (a) selected from the group consisting of a diisocyanate compound (a1), and a dihalogenated compound (a2) of formula (I): 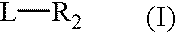
wherein R independently represents Cl, Br or I and L independently represents a CH₂ group, and
b. two molar equivalents of at least two different polyethoxylated compounds (b) selected from the group consisting of straight aliphatic monoalcohols (b1) comprising from 6 to 40 polyethoxylated carbon atoms and comprising from 80 to 500 ethoxylated groups, branched aliphatic monoalcohols (b2) comprising from 6 to 40 polyethoxylated carbon atoms and comprising from 80 to 500 ethoxylated groups, cycloaliphatic monoalcohols (b3) comprising from 6 to 40 polyethoxylated carbon atoms and comprising from 80 to 500 ethoxylated groups, monoaromatic monoalcohols (b4) comprising from 6 to 30 polyethoxylated carbon atoms and comprising from 80 to 500 ethoxylated groups, and polyaromatic monoalcohols (b5) comprising from 10 to 80 polyethoxylated carbon atoms and comprising from 80 to 500 ethoxylated groups.

10. The method according to claim 9 comprising a single reagent compound (a) or two or three different reagent compounds (a).

11. An aqueous composition comprising:
at least one difunctional compound T according to claim 1; and
at least one additive selected from the group consisting of
an amphiphilic compound,
a polysaccharide derivative,
a solvent, an anti foaming agent, and a biocide agent.

12. An aqueous formulation comprising:
at least one aqueous composition according to claim 11;
at least one organic or mineral pigment or organic, organo-metallic or mineral particles, and
at least one agent selected from the group consisting of a particle-spacer agent, a dispersing agent, a stabilising steric agent, an electrostatic stabiliser agent, an opacifying agent, a solvent, a coalescing agent, an anti-foaming agent, a preservative agent, a biocide agent, a spreading agent, a thickening agent, a film-forming copolymer, and mixtures thereof.

13. The aqueous formulation according to claim 12, wherein the aqueous formulation is; an ink formulation, a varnish formulation, a binder formulation, or a paint formulation.

14. A concentrated, water-based pigment pulp comprising at least one difunctional compound T according to claim 1 .

15. A method for controlling a viscosity of an aqueous composition comprising adding at least one difunctional compound T according to claim 1 to the aqueous composition.

16. A method for controlling a viscosity of the aqueous composition according to claim 11 comprising adding at least one difunctional compound T to the aqueous composition.
